(19) United States
(12) Patent Application Publication
(10) Pub. No.: US 2016/0050419 A1
(43) Pub. Date: Feb. 18, 2016

(54) DEPTH MODELING MODES FOR DEPTH MAP INTRA CODING

(71) Applicants: Xin ZHAO, (US); Li ZHANG, (US); Ying CHEN, (US); Marta KARCZEWICZ, San Diego, CA (US); QUALCOMM INCORPORATED, San Diego, CA (US)

(72) Inventors: Xin Zhao, San Diego, CA (US); Li Zhang, San Diego, CA (US); Ying Chen, San Diego, CA (US); Marta Karczewicz, San Diego, CA (US)

(21) Appl. No.: 14/777,212

(22) PCT Filed: Mar. 22, 2013
(86) PCT No.: PCT/CN2013/000339

§ 371 Date: Sep. 15, 2015

(51) Int. Cl. H04N 19/176; H04N 19/597; H04N 19/44; H04N 19/169

(52) U.S. Cl. CPC H04N 19/176; H04N 19/1887; H04N 19/597; H04N 19/44

(57) ABSTRACT

In an example, a process for coding video data includes coding, with a variable length code, a syntax element indicating depth modeling mode (DMM) information for coding a depth block of video data. The process also includes coding the depth block based on the DMM information.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a picture or a portion of a picture) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the spatial domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

The techniques of this disclosure generally relate to techniques for intra-coding depth data in video coding. For example, a number of depth modeling modes (DMMs) may be used to intra-code a depth map. Aspects of this disclosure relate to techniques that limit the number and/or types of DMMs that are available for intra-coding depth data, thereby reducing the complexity associated with coding depth data. Aspects of this disclosure also relate to the manner in which DMMs are indicated, for example, in an encoded bitstream.

In an example, aspects of this disclosure relate to a method of coding video data that includes coding, with a variable length code, a syntax element indicating depth modeling mode (DMM) information for coding a depth block of video data, and coding the depth block based on the DMM information.

In another example, aspects of this disclosure relate to an apparatus for coding video data that includes one or more processors configured to code, with a variable length code, a syntax element indicating depth modeling mode (DMM) information for coding a depth block of video data, and code the depth block based on the DMM information.

In another example, aspects of this disclosure relate to an apparatus for coding video data that includes means for coding, with a variable length code, a syntax element indicating depth modeling mode (DMM) information for coding a depth block of video data, and means for coding the depth block based on the DMM information.

In another example, aspects of this disclosure relate to a non-transitory computer-readable medium storing instructions thereon that, when executed, cause one or more processors to code, with a variable length code, a syntax element indicating depth modeling mode (DMM) information for coding a depth block of video data, and code the depth block based on the DMM information.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system 10 that may utilize the techniques of this disclosure for depth coding.

FIG. 2 is a block diagram illustrating an example of video encoder that may implement techniques for depth coding.

FIG. 3 is a block diagram illustrating an example of video decoder that may implement techniques for depth coding.

FIG. 4 generally illustrates the prediction directions associated with directional intra-prediction modes.

FIG. 5 is a conceptual diagram illustrating a region boundary chain coding mode.

FIG. 6 is a block diagram illustrating intra-coding depth information using simplified depth coding (SDC).

FIGS. 7A and 7B are conceptual diagrams illustrating examples of depth modeling modes (DMMs).

FIG. 8 is a flow diagram illustrating an example process for encoding depth data based on a DMM, according to aspects of this disclosure.

FIG. 9 is a flow diagram illustrating an example process for decoding depth data based on a DMM, according to aspects of this disclosure.

### DETAILED DESCRIPTION

In general, the techniques of this disclosure are related to three-dimensional (3D) video coding. That is, video data coded using these techniques may be rendered and displayed to produce a three-dimensional effect. For example, two images of different views (that is, corresponding to two camera perspectives having slightly different horizontal positions) may be displayed substantially simultaneously such that one image is seen by a viewer's left eye, and the other image is seen by the viewer's right eye.

This 3D effect may be achieved using, for example, stereoscopic displays or autostereoscopic displays. Stereoscopic displays may be used in conjunction with eyewear that filters the two images accordingly. For example, passive glasses may filter the images using polarized lenses or different colored lenses to ensure that the proper eye views the proper image. Active glasses, as another example, may rapidly shutter alternate lenses in coordination with the stereoscopic display, which may alternate between displaying the left eye image and the right eye image. Autostereoscopic displays display the two images in such a way that no glasses are needed. For example, autostereoscopic displays may include mirrors or prisms that are configured to cause each image to be projected into a viewer's appropriate eyes.

The techniques of this disclosure relate to techniques for coding 3D video data by coding texture and depth data. In general, the term “texture” is used to describe luminance (that is, brightness or “luma”) values of an image and chrominance (that is, color or “chroma”) values of the image. In some examples, a texture image may include one set of luminance data and two sets of chrominance data for blue hues (Cb) and red hues (Cr). In certain chroma formats, such as 4:2:2 or 4:2:0, the chroma data is downsampled relative to the luma data. That is, the spatial resolution of chrominance pixels may be lower than the spatial resolution of corresponding luminance pixels, e.g., one-half or one-quarter of the luminance resolution.

Depth data generally describes depth values for corresponding texture data. For example, a depth image may include a set of depth pixels (or depth values) that each describes depth for corresponding texture data. Each pixel may have one or more texture values (e.g., luminance and chrominance), and may also have a one or more depth values. The depth data may be used to determine horizontal disparity for the corresponding texture data, and in some cases, vertical disparity may also be used. A device that receives the texture and depth data may display a first texture image for one view (e.g., a left eye view) and use the depth data to modify the first texture image to generate a second texture image for the other view (e.g., a right eye view) by offsetting pixel values of the first image by the horizontal disparity values determined based on the depth values. In general, horizontal disparity (or simply “disparity”) describes the horizontal spatial offset of a pixel in a first view to a corresponding pixel in the right view, where the two pixels correspond to the same portion of the same object as represented in the two views.

In still other examples, depth data may be defined for pixels in a z-dimension perpendicular to the image plane, such that a depth associated with a given pixel is defined relative to a zero disparity plane defined for the image. Such depth may be used to create horizontal disparity for displaying the pixel, such that the pixel is displayed differently for the left and right eyes, depending on the z-dimension depth value of the pixel relative to the zero disparity plane. The zero disparity plane may change for different portions of a video sequence, and the amount of depth relative to the zero-disparity plane may also change. Pixels located on the zero disparity plane may be defined similarly for the left and right eyes. Pixels located in front of the zero disparity plane may be displayed in different locations for the left and right eye (e.g., with horizontal disparity) so as to create a perception that the pixel appears to come out of the image in the z-direction perpendicular to the image plane. Pixels located behind the zero disparity plane may be displayed with a slight blur, to slight perception of depth, or may be displayed in different locations for the left and right eye (e.g., with horizontal disparity that is opposite that of pixels located in front of the zero disparity plane). Many other techniques may also be used to convey or define depth data for an image.

Two-dimensional video data is generally coded as a sequence of discrete pictures, each of which corresponds to a particular temporal instance. That is, each picture has an associated playback time relative to playback times of other images in the sequence. These pictures may be considered texture pictures or texture images. In depth-based 3D video coding, each texture picture in a sequence may also correspond to a depth map. That is, a depth map corresponding to a texture picture describes depth data for the corresponding texture picture. Multiview video data may include data for various different views, where each view may include a respective sequence of texture pictures and corresponding depth pictures.

As noted above, images may correspond to a particular temporal instance. Video data may be represented using a sequence of access units, where each access unit includes all data corresponding to a particular temporal instance. Thus, for example, for multiview video data plus depth, texture images from each view for a common temporal instance, plus the depth maps for each of the texture images, may all be included within a particular access unit. An access unit may include data for a texture component, corresponding to a texture image, and a depth component, corresponding to a depth map.

In this manner, 3D video data may be represented using a multiview video plus depth format, in which captured or generated views (texture) are associated with corresponding depth maps. Moreover, in 3D video coding, textures and depth maps may be coded and multiplexed into a 3D video bitstream. Depth maps may be coded as grayscale images, where “luma” samples (that is, pixels) of the depth maps represent depth values. In general, a block of depth data (a block of samples of a depth map) may be referred to as a depth block. A depth value may refer to a luma value associated with a depth sample. In any case, conventional intra- and inter-coding methods may be applied for depth map coding.

Depth maps commonly include sharp edges and constant areas, and edges in depth maps typically present strong correlations with corresponding texture data. Due to the different statistics and correlations between texture and corresponding depth, different coding schemes have been and continue to be designed for depth maps based on a 2D video codec.

Techniques of this disclosure generally relate to coding depth data, and may be applicable to the High Efficiency Video Coding (HEVC) standard. For example, the Joint Video Team (JVT) recently developed a base version (2D) of HEVC that provides higher efficiency than previously developed video coding standards. A Joint Collaboration Team on 3D Video Coding (JCT-3V) is currently conducting study of two three-dimensional video (3DV) solutions as extensions to HEVC. One example includes a multi-view extension of HEVC that is referred to as MV-HEVC. Another example includes a depth enhanced 3D video extension (3D-HEVC). Currently, the HEVC-based 3D Video Coding (3D-HEVC) codec in MPEG is based on the solutions proposed in submissions m22570 and m22571. The latest reference software HTM version 6.0 for 3D-HEVC is available from https://hevc.hhi.fraunhofer.de/svn/svn_{—}3DVCSoftware/tags/HTM-6.0/. The latest software description (document number: B1005) is available from http://phenix.it-sudparis.eu/jct2/doc_end_user/documents/2_Shanghai/wg11/JCT3V-B1005-v1.zip.

In 3D-HEVC, each access unit contains multiple view components, each contains a unique view id, or view order index, or layer id. A view component contains a texture view component as well as a depth view component. A texture view component may be coded as one or more texture slices, while a depth view component may be coded as one or more depth slices.

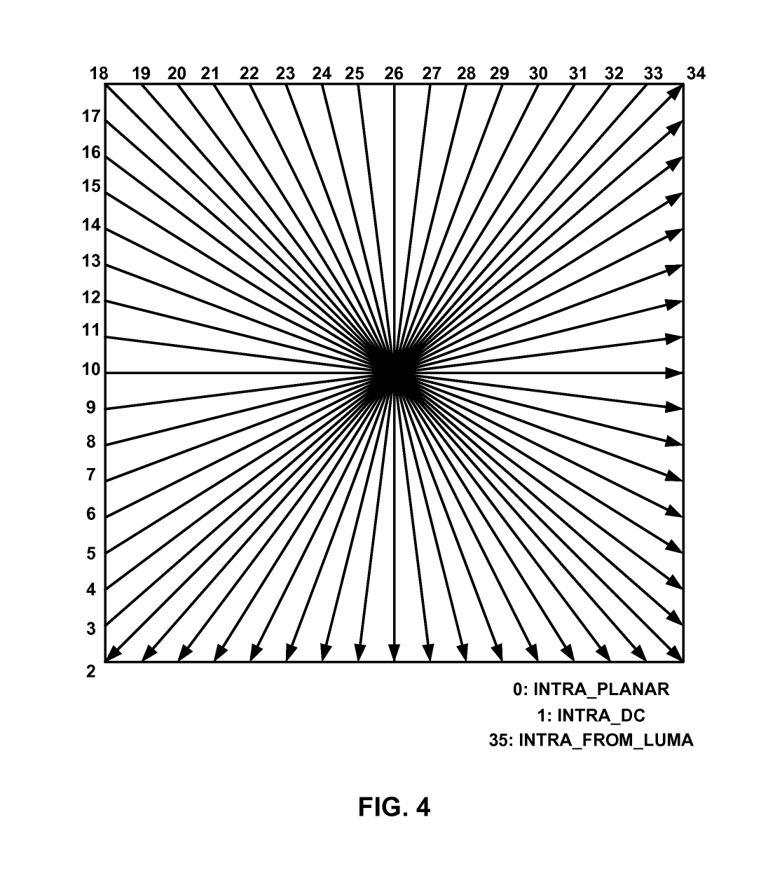

In some instances, depth data may be intra-coded, which relies on spatial prediction to reduce or remove spatial redundancy within a given picture. For example, in 3D-HEVC, a video coder (e.g., a video encoder or video decoder) may use intra-prediction modes from the base (2D) HEVC standard to code an intra-prediction unit of a depth slice. Intra-modes of the HEVC standard are described in greater detail below with respect to FIG. 4.

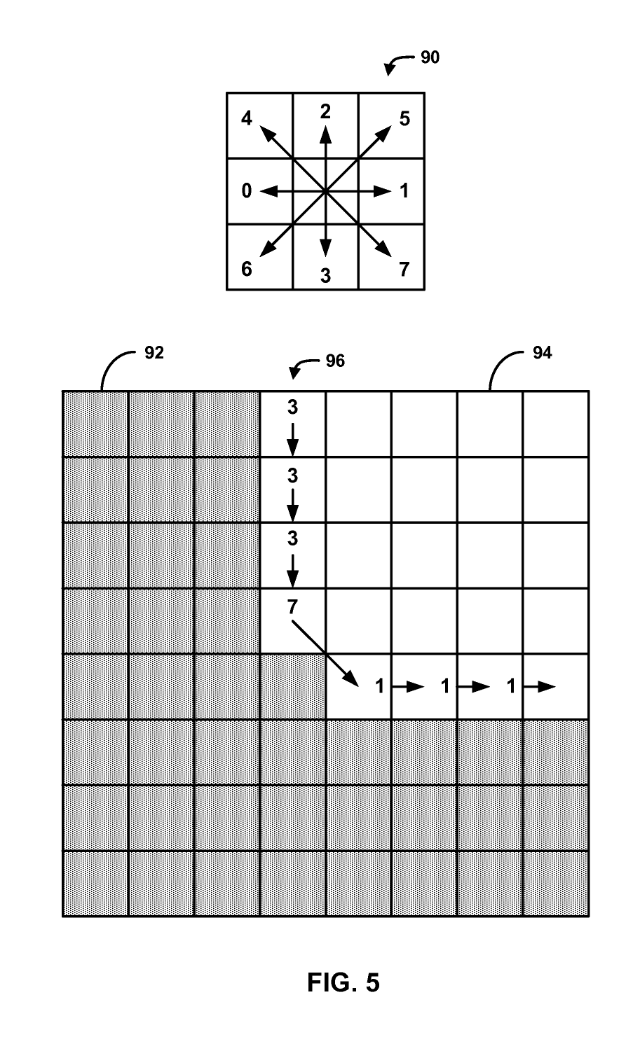

In another example, the video coder may use region boundary chain coding to code an intra-prediction unit of a depth slice. Region boundary chain coding (referred to as simply “chain coding”) is described in greater detail below with respect to FIG. 5. In general, the video coder may use chain coding to partition a block of depth data into irregularly shaped regions, which may then be intra-coded.

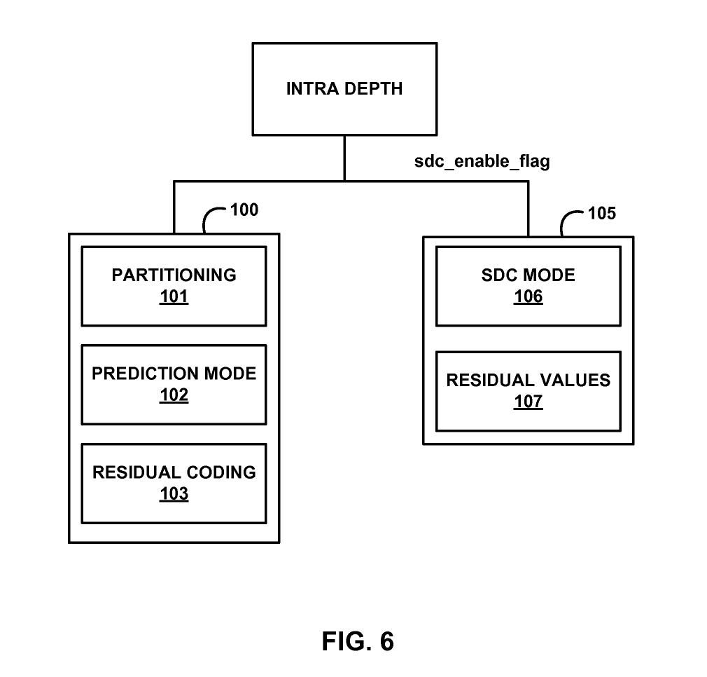

In still another example, the video coder may use a simplified depth coding (SDC) mode to code an intra-prediction unit of a depth slice. SDC is described in greater detail below with respect to FIG. 6. In contrast to other intra-mode coding schemes, when using an SDC mode, the video coder does not transform or quantize the residual depth values. Rather, the video coder may directly code a residual depth values.

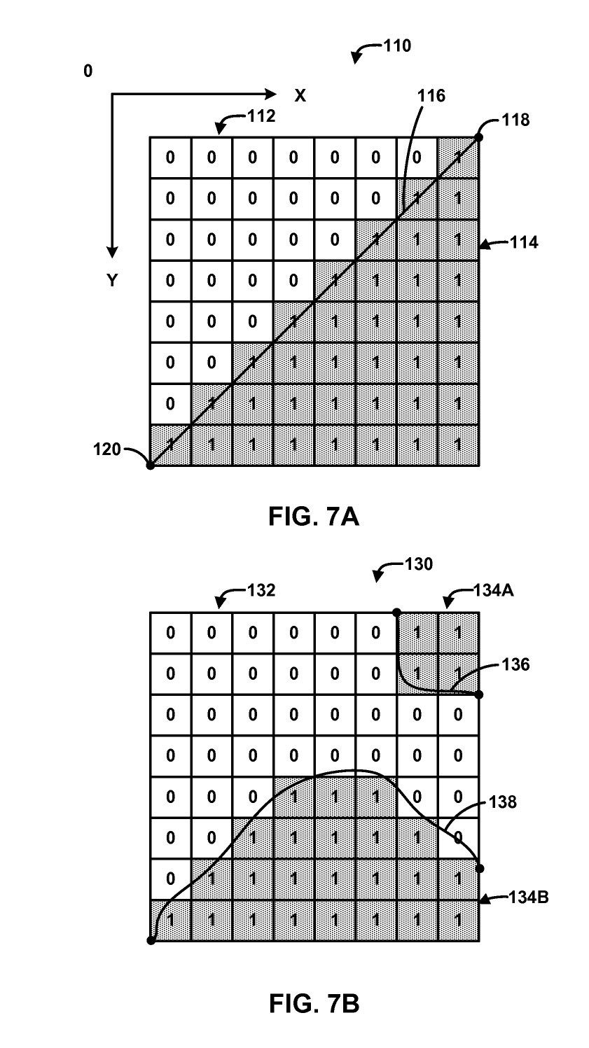

In another example, the video coder may use depth modeling modes (DMMs) to code an intra-prediction unit of a depth slice. DMMs of 3D-HEVC are described in greater detail below with respect to FIGS. 7A and 7B. With DMM, the video coder may partition a block of depth data (referred to generally as a depth block) into prediction regions. For example, the video coder may partition a block of depth data using a Wedgelet pattern, defined by an arbitrary line drawn through the block of depth data, or a Contour pattern, which partitions the depth block into two irregularly-shaped regions.

With respect to DMMs in 3D-HEVC, the video coder may apply one of four DMM modes. In all four modes, the video coder partitions a depth block into more than one region, as specified by a DMM pattern. That is, the DMM pattern indicates partition boundaries for each region (partition) of the depth block. The video coder then generates a single predicted depth value for each region. The video coder may generate a single predicted value for an entire partition based the values of neighboring depth samples (e.g., an average of neighboring depth samples). A single predicted depth value may be referred to as a “DC predicted depth value” or a “constant partition value (CPV),” both of which generally refer to a single predicted value that is applied to predict an entire region/partition.

In any case, the DMM pattern used by the video coder to define regions separated by a partition boundary may be explicitly signaled, predicted from spatially neighboring depth blocks, and/or predicted from a co-located texture block. For example, partition starting and/or ending points of a depth block determined using DMM mode 1 may be explicitly signaled. Partition boundaries of a depth block determined using DMM mode 2 may be based on spatially neighboring depth blocks. Partition boundaries of a depth block determined using DMM modes 3 and 4 may be based on a co-located texture block.

Determining partitioning boundaries of a depth block using DMM mode 2 may introduce complexity to the depth map coding process. For example, as described in greater detail below, a video coder may predict partition boundaries using DMM mode 2 based on an extension of a partition boundary from a neighboring depth block into a depth block currently being coded. In another example, the video coder may predict partition boundaries using DMM mode 2 based on a prediction direction of neighboring depth samples, a slope associated with one or more neighboring depth samples (e.g., with respect to prediction direction), or other factors. Performing such boundary prediction calculations may be relatively complex for a video encoder and/or video decoder.

In addition, including four DMMs requires all four DMMs to be signaled from a video encoder to a video decoder. For example, upon selecting a DMM to code depth data at a video encoder, the video encoder provides an indication of the selected DMM to a video decoder in the encoded bitstream. The video decoder then determines the DMM to apply when decoding the depth data based on the indication in the bitstream. In some instances, a fixed length code may be used to indicate a selected DMM. In addition, as described in greater detail below, the fixed length code may also indicate whether a prediction offset (associated with the DC predicted value) is applied.

Aspects of this disclosure relate to limiting the number and/or types of DMMs that are available for intra-coding depth data, thereby reducing the complexity associated with coding depth data. Aspects of this disclosure also relate to the manner in which DMMs are indicated, for example, in an encoded bitstream.

With respect to limiting the number and/or types of DMMs that are available for intra-coding depth data, according to aspects of this disclosure, DMMs that predict partition boundaries from neighboring depth blocks may be disabled and/or removed, making such DMMs unavailable for coding depth data. For example, with specific respect to 3D-HEVC, according to aspects of this disclosure, DMM mode 2 may be removed from available DMMs and/or disabled, such that DMM mode 2 cannot be selected for coding depth data. In this example, the remaining DMMs may include DMM mode 1, which includes explicitly signaling partition boundaries, and DMM modes 3 and 4, which include predicting partition boundaries from co-located texture blocks.

In this way, the techniques of this disclosure may reduce the complexity associated with encoding and/or decoding depth data. For example, the techniques may eliminate the complexities associated with predicting partition boundaries, such as the complexities associated with predicting partition boundaries in DMM mode 2. In addition, modes that predict partition boundaries from neighboring depth blocks (rather than determining partition boundaries in other manners, as noted above) may have a relatively limited impact on coding performance. Accordingly, removing such modes (such as DMM mode 2) may not adversely affect coding performance in a significant way.

In addition, according to aspects of this disclosure, DMM information may be indicated using a variable length code. For example, as described in greater detail below, a variable length code may be used to signal DMM mode 1, DMM mode 3, and DMM mode 4 in an encoded bitstream. In some instances, the variable length code may also indicate whether a prediction offset is applied when coding depth data. The variable length code may allow DMM information to be indicated in an encoded bitstream with relatively fewer bits than the fixed length code noted above.

While certain techniques of this disclosure may generally be described with respect to 3D-HEVC (and DMM mode 2 of 3D-HEVC), the techniques are not limited in this way. The techniques described herein may also be applicable to other current standards or future standards not yet developed. For example, the techniques for depth coding may also be applicable to a multi-view extension of HEVC (e.g., so called MV-HEVC), a scalable extension to HEVC, or other current or future standards having a depth component.

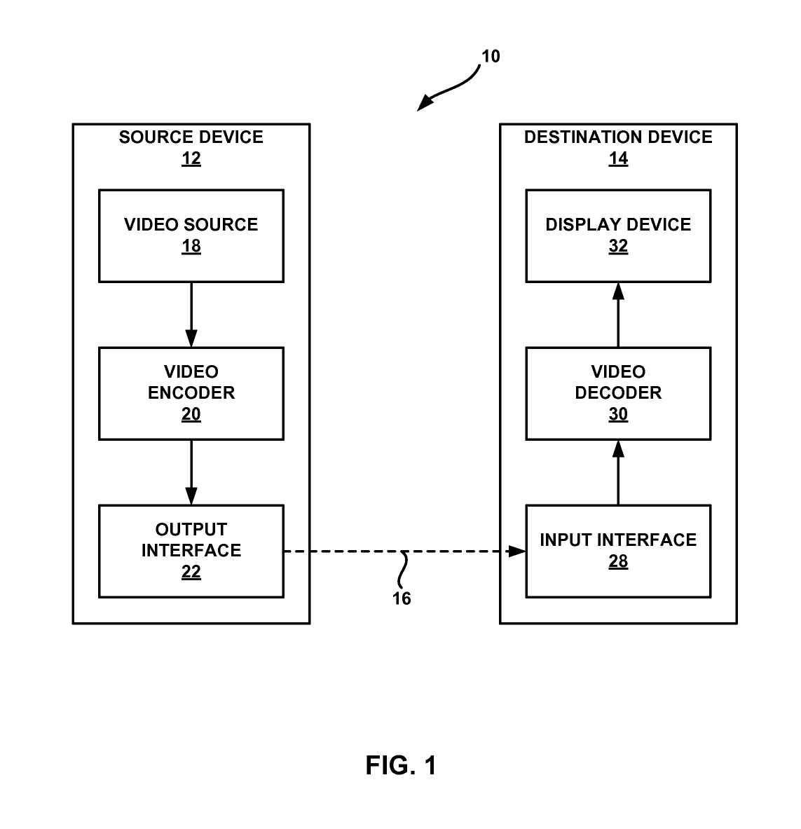

FIG. 1 is a block diagram illustrating an example video encoding and decoding system 10 that may utilize the techniques of this disclosure for depth coding. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time.

The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12.

Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for motion vector prediction in multi-view coding. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for depth coding may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to computer-readable medium 16) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

Video encoder 20 and video decoder 30 may operate according to a video coding standard, such as the ITU-T H.264/MPEG-4 (AVC) standard, which was formulated by the ITU-T Video Coding Experts Group (VCEG) together with the ISO/IEC Moving Picture Experts Group (MPEG) as the product of a collective partnership known as the Joint Video Team (JVT). Another video coding standard includes the H.264 standard, including its Scalable Video Coding (SVC) and Multiview Video Coding (MVC) extensions. The H.264 standard is described in ITU-T Recommendation H.264, Advanced Video Coding for generic audiovisual services, by the ITU-T Study Group. The Joint Video Team (JVT) continues to work on extensions to H.264/MPEG-4 AVC. The latest joint draft of MVC is described in “Advanced video coding for generic audiovisual services,” ITU-T Recommendation H.264, March 2010.

Alternatively, video encoder 20 and video decoder 30 may operate according to a High Efficiency Video Coding (HEVC) standard, and may conform to the HEVC Test Model (HM). HEVC was developed by JCT-VC of ITU-T VCEG and ISO/IEC MPEG. A recent draft of HEVC is available from http://phenix.int-evry.fr/jct/doc_end_user/documents/12_Geneva/wg11/JCTVC-L1003-v11.zip. The HEVC standardization efforts were based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-five intra-prediction encoding modes.

In general, the working model of the HM describes that a video picture (or “frame”) may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder 20 may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of pictures. As described herein, “picture” and “frame” may be used interchangeably. That is, picture containing video data may be referred to as video frame, or simply “frame.” A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

Video encoder 20 may further send syntax data, such as block-based syntax data, picture-based syntax data, and GOP-based syntax data, to video decoder 30, e.g., in a picture header, a block header, a slice header, or a GOP header. The GOP syntax data may describe a number of pictures in the respective GOP, and the picture syntax data may indicate an encoding/prediction mode used to encode the corresponding picture.

In some instances, video encoder 20 and/or video decoder 30 may intra-code depth data. For example, in 3D-HEVC, video encoder 20 and/or video decoder 30 may use depth modeling modes (DMMs) to code an intra-prediction unit of a depth slice. In some instances, four DMMs may be available for intra-coding depth data. In all four modes, video encoder 20 and/or video decoder 30 partitions a depth block into more than one region, as specified by a DMM pattern. Video encoder 20 and/or video decoder 30 then generates a predicted depth value for each region, which may be referred to as a “DC” predicted depth value that is based the values of neighboring depth samples.

The DMM pattern may be explicitly signaled, predicted from spatially neighboring depth blocks, and/or predicted from a co-located texture block. For example, a first DMM (e.g., DMM mode 1) may include signaling starting and/or ending points of a partition boundary of a depth block. A second DMM (e.g., DMM mode 2) may include predicting partition boundaries of a depth block based on a spatially neighboring depth block. Third and fourth DMMs (e.g., DMM mode 3 and DMM mode 4) may include predicting partition boundaries of a depth block based on a co-located texture block of the depth block.

Predicting partition boundaries from spatially neighboring depth blocks (as performed, for example, with DMM mode 2) may introduce complexity to the depth map coding process. For example, predicting a partition boundary from a spatially neighboring block may include extending the partition boundary from the spatially neighboring block into the block currently being coded. In another example, predicting a partition boundary from a spatially neighboring block may include determining a prediction direction of one or more neighboring samples, a prediction gradient of one or more samples, a prediction slope of one or more samples, or the like.

In addition, with four DMMs available, there may be signaling associated with each of the four DMMs (e.g., DMM modes 1-4). For example, video encoder 20 may select a DMM to code a depth PU based on a rate-distortion optimization. Video encoder 20 may provide an indication of the selected DMM in an encoded bitstream with the encoded depth data. Video decoder 30 may parse the indication from the bitstream to determine the appropriate DMM for decoding the depth data. In some instances, a fixed length code may be used to indicate a selected DMM. In addition, the fixed length code may also indicate whether a prediction offset (associated with a predicted DC value) is applied.

As noted above, aspects of this disclosure include limiting the number and/or types of DMMs that are available for intra-coding depth data, thereby reducing the complexity associated with coding depth data. In addition, aspects of this disclosure relate to the manner in which DMMs are signaled in an encoded bitstream.

For example, according to aspects of this disclosure, video encoder 20 and/or video decoder 30 may code, with a variable length code, a syntax element indicating DMM information for coding a depth block of video data. Video encoder 20 and/or video decoder 30 may also code the depth block based on the DMM information.

According to aspects of this disclosure, DMM information may include a DMM index for coding the depth block. The DMM index may identify a selected DMM for the depth block based on a rate-distortion optimization. For example, video encoder 20 may test a variety of intra-prediction techniques for intra-coding depth blocks (e.g., HEVC intra-prediction modes, DMMs, chain coding, SDC, and the like). Video encoder 20 may then perform a rate-distortion analysis for the various tested techniques, and select the intra-prediction mode having the best rate-distortion characteristics among the tested techniques. In instances in which video encoder 20 selects a DMM, video encoder 20 may indicate the selected DMM with an index to a table of DMMs. According to aspects of this disclosure, video encoder may signal the DMM index with a variable length code, as described in greater detail with respect to FIGS. 7A and 7B.

In some instances, the DMM information may also include an indication of whether a prediction offset is applied when coding the depth block. For example, video encoder 20 may determine a prediction offset in instances in which the predicted depth values from the DMM do not match the actual depth values of the depth block. The prediction offset may include one or more offset values, and may provide a pixel-by-pixel difference between the predicted depth value and the actual depth values of the block. The prediction offset may be used to adjust the predicted depth values so that they are equal to the predicted depth values. According to aspects of this disclosure, video encoder 20 may signal whether a prediction offset is applied to the depth block with the variable length code (e.g., the same variable length code that indicates the selected DMM). Video encoder 20 may also provide, separately, an indication of the actual prediction offset.

Video decoder 30 may receive data representing the DMM information and decode the depth block based on the DMM information. For example, according to aspects of this disclosure, video decoder 30 may parse a variable length bin string representing DMM information from an encoded bitstream. As noted above, the DMM information may include a DMM index, as well as an indication of whether to apply a prediction offset when predicting the depth block. Video decoder 30 may use this DMM information to generated a predicted block, and may reconstruct the depth block based on the predicted depth block, as described in greater detail below.

In this way, the techniques of this disclosure may reduce the complexity associated with encoding and/or decoding depth data. For example, the techniques may eliminate the complexities associated with predicting partition boundaries, such as the complexities associated with predicting partition boundaries in DMM mode 2. In addition, the techniques allow for DMM information to be provided using a variable length code, which may be more efficient (e.g., bit-wise) than other coding techniques, such as fixed length coding.

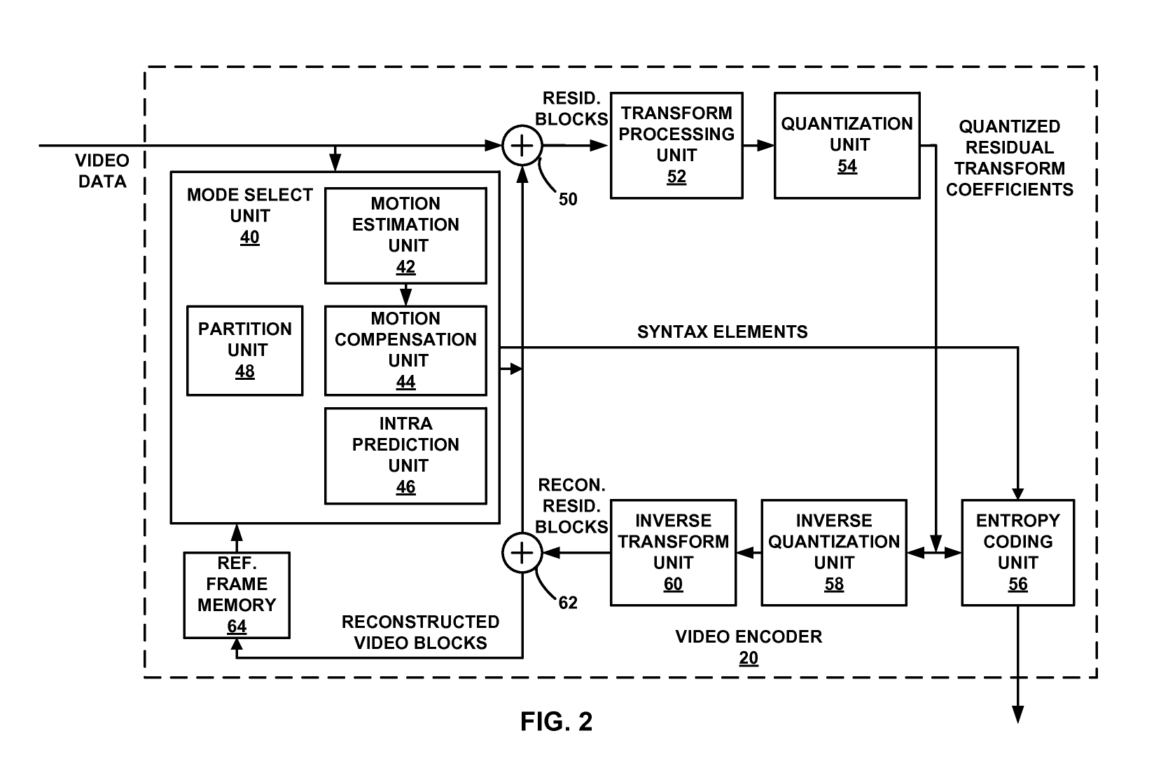

FIG. 2 is a block diagram illustrating an example of video encoder 20 that may implement techniques for depth coding. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As noted above, video encoder 20 may be adapted to perform mutliview video coding. In some instances, video encoder 20 may be configured to code multi-view HEVC, such that each view in a time instance may be processed by a decoder, such as video decoder 30. For HEVC-3D, in addition to encoding texture maps (i.e., luma and chroma values) for each view, video encoder 20 may further encode a depth map for each view.

In any case, as shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter). Example filers may include adaptive loop filters, sample adaptive offset (SAO) filters or other types of filters.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit).

A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

In addition, intra-prediction unit 46 may be configured to code depth blocks of a depth map. For example, intra-prediction unit 46 use intra-prediction modes from the base (2D) HEVC standard (as described, for example, with respect to FIG. 4 below), region boundary chain coding (as described, for example, with respect to FIG. 5 below), simplified depth coding (SDC) (as described, for example, with respect to FIG. 6 below), or depth modeling modes (DMMs) (as described, for example, with respect to FIGS. 7A and 7B below) to code an intra-predicted PU of a depth slice.

When encoding depth data using a DMM, intra-prediction unit 46 may split a depth block into partitions based on the DMM. Intra-prediction unit 46 may then generate a single predicted depth value for each partition based on neighboring depth samples. A single predicted depth value for a partition may be referred to as a DC predicted value or a constant partition value (CPV). In some instances, intra-prediction unit 46 may determine the DC predicted value based on an average of depth samples that neighbor the depth block currently being encoded.

Intra-prediction unit 46 may also determine a prediction offset, which may be referred to as delta DC values or delta CPV values. For example, in instances in which a DC predicted value does not match the actual values of a partition, intra-prediction unit 46 may determine one or more delta DCs based on a difference between the actual depth value of a partition and the DC predicted value. In this example, delta DCs may be provided on a per-sample basis. Intra-prediction unit 46 may indicate one or more delta DC values separately from the indication of the DMM mode.

According to aspects of this disclosure, intra-prediction unit 46 may be prevented from applying some intra-modes, including one or more DMMs. For example, intra-prediction unit 46 may avoid use of any intra-prediction modes that predict partition boundaries from spatially neighboring depth blocks. In this example, intra-prediction unit 46 may be prevented from selecting DMM mode 2 to intra-code depth data, e.g., when performing a rate-distortion analysis to determine an intra-mode for depth map coding. As described in greater detail below with respect to FIGS. 7A and 7B, removing DMM mode 2 from consideration may reduce the complexity of depth map coding.

Transform processing unit 52 applies the transform to the residual block, producing a block of residual transform coefficients. The transform may convert the residual information from a pixel value domain to a transform domain, such as a frequency domain. Transform processing unit 52 may perform transforms such as discrete cosine transforms (DCTs) or other transforms that are conceptually similar to DCT. Wavelet transforms, integer transforms, sub-band transforms or other types of transforms could also be used. Transform processing unit 52 may send the resulting transform coefficients to quantization unit 54.

Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

According to aspects of this disclosure, entropy encoding unit 56 may encode DMM information based on a variable length code. For example, video encoder 20 may indicate a particular DMM used to code a depth block using a DMM syntax element (e.g., dmm_mode). The DMM syntax element may provide a DMM index to a table of available DMMs, as well as an indication of whether to apply a DMM offset.

Table 1, shown below, provides one example of a variable length code that may be implemented by entropy encoding unit 56 to binarize a DMM syntax element. Entropy encoding unit 56 may then entropy encode the binaraized syntax element.

TABLE 1
Binarizaton of dmm_mode

| dmm_mode | DMM mode | Delta DC | Binary string |
|---|---|---|---|
| 0 | DMM mode 1 | not used | 00 |
| 1 | DMM mode 1 | used | 01 |
| 2 | DMM mode 3 | not used | 100 |
| 3 | DMM mode 3 | used | 101 |
| 4 | DMM mode 4 | not used | 110 |
| 5 | DMM mode 4 | used | 111 |

In the example of Table 1, the variable length code includes both a DMM mode index (which identifies the selected DMM) and an indication of whether to apply a prediction offset. As noted above, in instances in which a prediction offset is applied, entropy encoding unit 56 may entropy code the prediction offset following the DMM syntax element.

The example of Table 1 maps each of DMM mode 1 (with a prediction offset) and DMM mode 1 (without a prediction offset) to a two bit bin string. The remaining DMMs (without DMM mode 2) are represented using three bit bin strings. In other examples, the DMMs may be arranged in Table 1 differently. For example, the assignment of a particular DMM to a particular variable length bin string may depend on the frequency with which the particular DMM is applied. In this example, entropy encoding unit 56 may assign the shortest variable length codeword to the DMM that is most frequently applied for a particular depth map or series of depth maps.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation.

Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

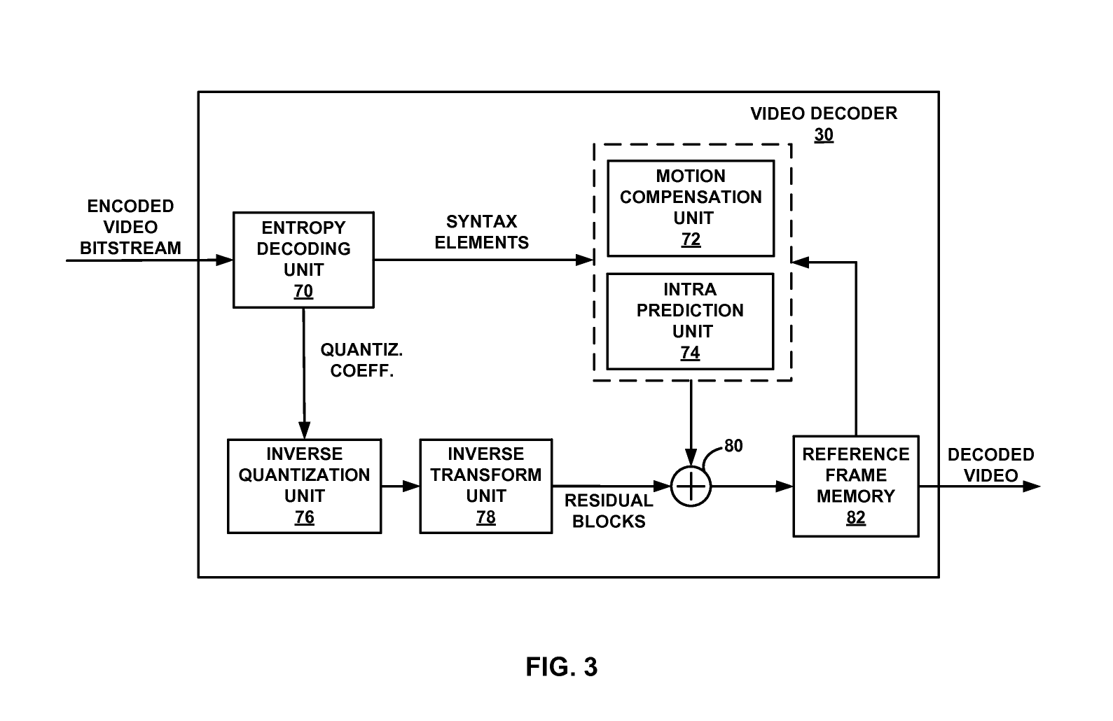

FIG. 3 is a block diagram illustrating an example of video decoder 30 that may implement techniques for depth coding. In the example of FIG. 3, video decoder 30 includes an entropy decoding unit 70, motion compensation unit 72, intra prediction unit 74, inverse quantization unit 76, inverse transformation unit 78, reference frame memory 82 and summer 80.

During the decoding process, video decoder 30 receives an encoded video bitstream that represents video blocks of an encoded video slice and associated syntax elements from video encoder 20. Entropy decoding unit 70 entropy decodes the bitstream to generate quantized coefficients, motion vectors or intra-prediction mode indicators, and other syntax elements. Video decoder 30 may receive the syntax elements at the video slice level and/or the video block level.

As noted above, video decoder 30 may be adapted to perform mutliview video coding. In some instances, video decoder 30 may be configured to decode multi-view HEVC. For HEVC-3D, in addition to decoding texture maps (i.e., luma and chroma values) for each view, video decoder 30 may further decode a depth map for each view.

According to aspects of this disclosure, when depth block is encoded using a DMM, entropy decoding unit 70 (or another component of video decoder 30) may parse a binarized DMM syntax element (e.g., dmm_mode) from an encoded bitstream. As noted above with respect to video encoder 20, the DMM syntax element may provide a DMM index to a table of available DMMs, as well as an indication of whether to apply a DMM offset. Accordingly, entropy decoding unit 70 may entropy decode a variable length bin string (e.g., as shown in the right-most column of Table 1 above) and determine a DMM for decoding a depth block, as well as whether to decode and apply a prediction offset to the depth block. In some instances, entropy decoding unit 70 may also apply the techniques described above to assign the shortest variable length codewords to the most used DMMs.

In any case, when the video slice is coded as an intra-coded (I) slice, intra-prediction unit 74 may generate prediction data for a video block of the current video slice based on a signaled intra prediction mode and data from previously decoded blocks of the current frame or picture.

Intra-prediction unit 74 may also intra-code depth data. For example, intra-prediction unit 74 may use intra-prediction modes from the base (2D) HEVC standard (as described, for example, with respect to FIG. 4 below), region boundary chain coding (as described, for example, with respect to FIG. 5 below), simplified depth coding (SDC) (as described, for example, with respect to FIG. 6 below), or depth modeling modes (DMMs) (as described, for example, with respect to FIGS. 7A and 7B below) to code an intra-predicted PU of a depth slice.

When decoding depth data using a DMM, intra-prediction unit 74 may split a predicted depth block into partitions based on the DMM. As noted above, according to aspects of this disclosure, intra-prediction unit 74 may determine the DMM for decoding a depth block based on a variable length code that maps a bin string to a DMM index. Intra-prediction unit 74 may also determine whether to apply a prediction offset to the predicted depth block from the bin string.

Intra-prediction unit 74 may then generate a single predicted depth value for each partition based on neighboring depth samples. In some instances, intra-prediction unit 74 may determine the DC predicted value based on an average of depth samples that neighbor the depth block currently being encoded.

Intra-prediction unit 74 may also determine a prediction offset (e.g., delta DC/delta CPV) in instances in which a prediction offset was determined and signaled at the video encoder (such as video encoder 20). That is, intra-prediction unit 74 may retrieve one more prediction offset values from an encoded bitstream. In this example, delta DCs may be provided on a per-sample basis. Intra-prediction unit 74 may combine the prediction offset values with the predicted depth values to reconstruct the depth block.

According to aspects of this disclosure, intra-prediction unit 74 may be prevented from applying some intra-modes, including one or more DMMs. For example, intra-prediction unit 74 may avoid use of intra-prediction modes that predict partition boundaries from spatially neighboring depth blocks. In this example, intra-prediction unit 74 may avoid performing DMM mode 2 to intra-code depth data. As described in greater detail below with respect to FIGS. 7A and 7B, removing DMM mode 2 from consideration may reduce the complexity of depth map coding.

When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 92.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 80. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 82 or intra-prediction unit 74 generates the predictive block for the current video block (e.g., a texture block or a depth block) based on motion vectors or other syntax elements, video decoder 30 forms a decoded video block by summing the residual blocks from inverse transform unit 78 with the corresponding predictive blocks generated by motion compensation unit 82 or intra-prediction unit 74. Summer 90 represents the component or components that perform this summation operation.

If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference frame memory 82 also stores decoded video for later presentation on a display device, such as display device 32 of FIG. 1.

FIG. 4 generally illustrates the prediction directions associated with directional intra-prediction modes. For example, as noted above, the HEVC standard may include thirty five intra-prediction modes, including a planar mode (mode 0), a DC mode (mode 1) and 33 directional prediction modes (modes 2-34). With planar mode, prediction is performed using a so-called “plane” function. With DC mode, prediction is performed based on an averaging of pixel values within the block. With a directional prediction mode, prediction is performed based on a neighboring block's reconstructed pixels along a particular direction (as indicated by the mode). In general, the tail end of the arrows shown in FIG. 4 represents a relative one of neighboring pixels from which a value is retrieved, while the head of the arrows represents the direction in which the retrieved value is propagated to form a predictive block.

The intra-modes shown in FIG. 4 may be used for predicting depth values. For example, each of the angular intra-prediction modes shown in FIG. 4 may be associated with a set of Wedgelet patterns, as described in greater detail below with respect to FIGS. 7A and 7B.

FIG. 5 is a conceptual diagram illustrating a region boundary chain coding mode. For example, 3D-HEVC includes a region boundary chain coding mode that allows explicit signaling of partition boundaries (e.g., rather than partitioning based on co-located texture, as described above with respect to DMMs). This disclosure may refer to “region boundary chain coding mode” as “chain coding.”

In general, a chain is a connection between a sample and one of its eight-connectivity samples. As shown by block 90 of FIG. 5, there are eight different chain direction types, each assigned with a direction index ranging from 0 to 7. The chain direction types may aid a video coder in determining partitions of a depth block.

For example, the example of FIG. 5 includes a first partition 92 and a second partition 94 separated by a chain 96 that indicates the partitioning structure. A video encoder (such as video encoder 20) may determine and signal chain 96 for a PU in an encoded bitstream, while a video decoder (such as video decoder 30) may parse data representing chain 96 from an encoded bitstream.

In general, chain 96 includes a starting position, an indication of a number of links in the chain (e.g., a number of chain codes), and for each chain code, a direction index. To signal the arbitrary partition pattern shown in the example of FIG. 5, video encoder 20 may encode one bit (e.g., 0) to indicate that chain 96 begins from the top boundary. Video encoder 20 may encode three bits (e.g., 011) to indicate that chain 96 begins after the third depth sample of the top boundary. Video encoder 20 may encode four bits (e.g., 0110) to indicate that there are 7 total links in chain 96. Video encoder 20 may also encode a series of connected chains indexes (e.g., 3, 3, 3, 7, 1, 1, 1) to indicate the direction of each chain link (e.g., in accordance with block 90). In some examples, video encoder 20 may convert each index to a code word using a look-up-table. A video decoder, such as video decoder 30, may parse the signaling described above to determine the partitioning pattern of a block. Video decoder 30 may then decode depth values for each partition.

FIG. 6 is a block diagram illustrating intra-coding depth information using simplified depth coding (SDC). In the example of FIG. 6, a video coder (such as video encoder 20 or video decoder 30) may use any of the intra-prediction modes described above (HEVC modes, DMMs, chain coding) to intra-predict depth information using left branch 100. In such examples, the video coder may perform partitioning (e.g., Wedgelet, Contour, chain, or the like) 101, determine a prediction mode 102 (e.g., HEVC intra-modes, DMMs, or the like), and perform residual coding 103.

Alternatively, an SDC syntax element (e.g., sdc_enable_flag) may indicate SDC coding according to right branch 105. For example, when implementing SDC, the video coder may determine an SDC sub-mode 106 and directly code residual values 107 (e.g., without transformation and quantization).

In some instances, SDC may only be applied for a 2N×2N PU partition size. As noted above, instead of coded quantized transform coefficients, SDC modes represent a depth block based on a type of partition of the current depth block (e.g., DC (1 partition), DMM mode 1 (2 partitions), DMM mode 2 (2 partitions), or planar (1 partition). In addition, as noted above, a residual value in the pixel domain is provided for each partition.

Accordingly, four sub-modes may be defined in SDC, including SDC mode 1, SDC mode 2, SDC mode 3 and SDC mode 4, which correspond to the partition type of DC, DMM mode 1, DMM mode 2 and planar, respectively. According to aspects of this disclosure, in some examples, DMM mode 2 may be disabled, such that DMM mode 2 is not available for intra-coding depth blocks for SDC. In this example, another intra-mode may replace DMM mode 2 in SDC.

In some instances, depth values may be optionally mapped to indexes using a Depth Lookup Table (DLT), which may constructed by analyzing the frames within the first intra period before encoding the full sequence. If DLT is used, the entire DLT is transmitted to decoder in sequence parameter set, and decoded index values are mapped back to depth values based on the DLT.

FIGS. 7A and 7B are conceptual diagrams illustrating examples of depth modeling modes (DMMs). FIG. 7A, for example, illustrates depth block 110 that is partitioned using Wedgelet partitioning, and FIG. 7B, as another example, illustrates depth block 130 that is partitioned using Contour partitioning. 3D-HEVC includes techniques for depth modeling modes (DMMs) for partitioning blocks along with the intra-prediction modes to code an intra-prediction unit of a depth slice. HTM version 3.1 applies a DMM method for intra coding of depth maps, which may better represent sharper edges in depth maps in some cases.

For example, 3D-HEVC provides four DMM modes: Mode 1 (explicit Wedgelet signaling), Mode 2 (intra-predicted Wedgelet partitioning), Mode 3 (inter-component Wedgelet partitioning), and Mode 4 (inter-component Contour partitioning). In all four modes, a video coder, such as video encoder 20 or video decoder 30, may partition a depth block into two regions specified by a DMM pattern, where each region is represented by a constant value. The DMM pattern can be either explicitly signaled (mode 1), predicted by spatially neighboring blocks (mode 2), or predicted using a co-located texture block (mode 3 and mode 4).

There are at least two partitioning models defined in DMM, including Wedgelet partitioning and the Contour partitioning. Again, FIG. 7A illustrates an example of Wedgelet partitioning, and FIG. 7B illustrates an example of Contour partitioning. Each individual square within depth blocks 110 and 130 represents a respective individual pixel of depth blocks 110 and 130, respectively. Numeric values within the squares represent whether the corresponding pixel belongs to region 112 (value “0” in the example of FIG. 7A) or region 114 (value “1” in the example of FIG. 7A). Shading is also used in FIG. 7A to indicate whether a pixel belongs to region 112 (white squares) or region 114 (grey shaded squares).

Each pattern (that is, both Wedgelet and Contour) may be defined by an array of size u_{B}×v_{B} binary digit labeling of whether the corresponding sample (that is, pixel) belongs to region P₁ or P₂ (where P₁ corresponds to region 112 in FIG. 7A and region 132 in FIG. 7B, and P₂ corresponds to region 114 in FIG. 7A and region 134A, 134B in FIG. 7B), where u_{B} and v_{B} represent the horizontal and vertical size of the current PU, respectively. In the examples of FIG. 7A and FIG. 7B, the PU corresponds to blocks 110 and 130, respectively. Video coders, such as video encoder 20 and video decoder 30, may initialize Wedgelet patterns at the beginning of coding, e.g., the beginning of encoding or the beginning of decoding.

As shown in the example of FIG. 7A, for a Wedgelet partition, depth block 110 is partitioned into two regions, region 112 and region 114, by straight line 116, with start point 118 located at (Xs, Ys) and end point 120 located at (Xe, Ye). In the example of FIG. 7A, start point 118 may be defined as point (8, 0) and end point 120 may be defined as point (0, 8).

As shown in the example of FIG. 7B, for Contour partitioning, a depth block, such as depth block 130, can be partitioned into two irregularly-shaped regions. In the example of FIG. 7B, depth block 130 is partitioned into region 132 and region 134A, 134B. Although pixels in region 134A are not immediately adjacent to pixels in region 134B, regions 134A and 134B are defined to form one single region, for the purposes of predicting a PU of depth block 130. The Contour partitioning is more flexible than the Wedgelet partitioning, but may be relatively more difficult to signal. In DMM mode 4, in the case of 3D-HEVC, Contour partitioning pattern is implicitly derived using reconstructed luma samples of the co-located texture block.

In this manner, a video coder, such as video encoder 20 and video decoder 30, may use line 116, as defined by start point 118 and end point 120, to determine whether a pixel of depth block 110 belongs to region 112 (which may also be referred to as region “P₁”) or to region 114 (which may also be referred to as region “P₂”). Likewise, a video coder may use lines 136, 138 of FIG. 7B to determine whether a pixel of depth block 130 belongs to region 132 (which may also be referred to as region “P₁”) or to region 134 (which may also be referred to as region “P₂”). Regions “P1” and “P2” are default naming conventions for different regions partitioned according to DMM, and thus, region P₁ of depth block 110 should not be considered the same region as region P₁ of depth block 130.

As noted above, each of the DMMs may be defined by whether the DMM uses Wedgelet or Contour partitioning, and whether the pattern is explicitly signaled or implicitly determined. The DMM process may be integrated as an alternative to the intra prediction modes specified in HEVC (shown in FIG. 4). A one bit flag may be signaled for each PU to specify whether DMM or conventional intra prediction is applied.

With respect to DMM mode 2, video encoder 20 or video decoder 30 may apply Wedgelet partitioning when predicting a depth block, such as depth block 110 or depth block 130. In one example, video encoder 20 or video decoder 30 may predict the Wedgelet partition boundary for the current block based on a spatially neighboring block coded using Wedgelet partitioning. In this example, the partitioning line of the Wedgelet pattern applied to the neighboring block is extended into the block currently being coded. A predicted start point and a predicted end point may also be used to define the partition boundary for the current block.

In another example, video encoder 20 or video decoder 30 may predict the Wedgelet partition boundary for the current block based on a spatially neighboring block coded using a conventional intra-prediction mode (such as those described with respect to FIG. 4 above). In this example, a gradient may be initially derived from the intra-prediction direction. Because the intra direction is only provided in the form of an abstract index, a mapping or conversion function may be defined that associates each intra-prediction mode with a gradient. Next, a predicted start point may derived based on the reference sample position with maximum slope. A predicted end point is obtained using the derived start position and the gradient value reflected by the intra-prediction direction applied on the neighboring depth block.

For both the above cases, the end position of the predicted partition boundary is allowed to move along the current block boundary within a range of values to make the Wedgelet pattern more accurate. The difference between the predicted end position and the actual end position of the partition boundary may be explicitly signaled.

Table 2, shown below, provides one example of coding unit syntax for indicating a DMM.

TABLE 2
DMM Coding Unit Syntax
G.7.3.9.1 General Coding unit syntax

| | Descriptor |
|---|---|
| coding_unit( x0, y0, log2CbSize , ctDepth) { | |
| ... | ... |

pbOffset = ( PartMode = = PART_NxN ) ?

( nCbS / 2 ) : 0

if ( enable_DMM_flag && log2CbSize <=

Log2MaxDmmCbSize ) {

for( j = 0; j <= pbOffset; j = j + pbOffset )

for( i = 0; i <= pbOffset; i = i + pbOffset )

| | |
|---|---|
| dmm_flag[ x0 + i ][ y0+ j ] | ae(v) |

for( j = 0; j <= pbOffset; j = j + pbOffset )

for( i = 0; i <= pbOffset; i = i + pbOffset )

if (dmm_flag[ x0 + i ][ y0+ j ] )

| | |
|---|---|
| dmm_mode[ x0 + i ][ y0+ j ] | ae(v) |

| | |
|---|---|
| ... | ... |

As defined in the working draft of 3D-HEVC, the syntax element dmm_flag is one bit flag signaling whether DMM mode or intra prediction mode is applied, and the syntax element dmm_mode is signaled to identify which DMM mode is used and whether delta DC value is applied. For example, a dmm_flag[x0][y0] set equal to 0 may specify that DMMs are not used. A dmm_flag[x0][y0] set equal to 1 may specify that a DMM is used, and that a dmm_mode syntax element is also present. When the dmm_flag[x0][y0] is not present, its value may be inferred to be equal to 0.

In addition, dmm_mode[x0][y0] may be set to one of the values shown in Table 3 below.

TABLE 3
Interpretation of dmm_mode

| dmm_mode | Method identifier |
|---|---|
| 0 | MODE_DMM_WFULL |
| 1 | MODE_DMM_WFULLDELTA |
| 2 | MODE_DMM_WPREDTEX |
| 3 | MODE_DMM_WPREDTEXDELTA |
| 4 | MODE_DMM_CPREDTEX |
| 5 | MODE-DMM_CPREDTEXDELTA |
| 6 | MODE_DMM_WPREDDIR |
| 7 | MODE_DMM_WPREDDIRDELTA |

Each possible value of dmm_mode (0, 1, . . . , 7) may be associated with a method identifier, and each method identifier may be connected to a specific usage of a DMM mode and a delta DC. An example correlation between the dmm_mode syntax element and method identifiers is provided in Table 4 below.

TABLE 4
Connection Between Method Identifier
and Usage of DMM and Delta DC

| Method identifier | DMM mode | Delta DC |
|---|---|---|
| MODE_DMM_WFULL | DMM mode 1 | not used |
| MODE_DMM_WFULLDELTA | DMM mode 1 | Used |
| MODE_DMM_WPREDDIR | DMM mode 2 | not used |
| MODE_DMM_WPREDDIRDELTA | DMM mode 2 | Used |
| MODE_DMM_WPREDTEX | DMM mode 3 | not used |
| MODE_DMM_WPREDTEXDELTA | DMM mode 3 | Used |
| MODE_DMM_CPREDTEX | DMM mode 4 | not used |
| MODE_DMM_CPREDTEXDELTA | DMM mode 4 | Used |

According to the working draft of 3D-HEVC, the value of the dmm_mode syntax element (from Table 3 above) may be binarized according to the fixed length codes shown in Table 5 below.

TABLE 5
Fixed Length Binarization of dmm_mode

Binary string

| | PU size | PU size larger |
|---|---|---|
| dmm_mode | equals 4 × 4 | than 4 × 4 |
| 0 | 00 | 000 |
| 1 | 10 | 100 |
| 2 | 01 | 010 |
| 3 | 11 | 110 |
| 4 | N/A | 001 |
| 5 | N/A | 101 |
| 6 | N/A | 011 |
| 7 | N/A | 111 |

In the example above, each bin of the binary string may be coded using CABAC. The binarization of dmm_mode depends on the PU size. For example, if a PU is 4×4 in size, the dmm_mode syntax element may be binarized using a fixed length code with 2 bits. If a PU is larger than 4×4 in size, the dmm_mode syntax element may be binarized using a fixed length code with 3 bits.

As noted above, the techniques of this disclosure include limiting the number and/or types of DMMs that are available for intra-coding depth data. For example, according to aspects of this disclosure, DMMs that predict partition boundaries from neighboring depth blocks may be disabled and/or removed, making such DMMs unavailable for coding depth data. For example, with specific respect to 3D-HEVC, according to aspects of this disclosure, DMM mode 2 may be removed from available DMMs and/or disabled, such that DMM mode 2 cannot be selected for coding depth data.

In this example, the remaining DMMs may include DMM mode 1, which includes explicitly signaling partition boundaries, and DMM modes 3 and 4, which include predicting partition boundaries from co-located texture blocks. In some examples, the DMMs that are available may depend on the size of the depth PU being coded. For example, DMM mode 2 may always be disabled/removed. DMM modes 1 and 3 may be enabled for 4×4 PUs to 64×64 PUs. DMM mode 4 may be enabled for 8×8 PUs to 32×32 PUs. Other DMM size restrictions are also possible.

By removing one of the DMMs, according to aspects of this disclosure, DMM information may be indicated using a variable length code. For example, a variable length code may be used to signal DMM mode 1, DMM mode 3, and DMM mode 4 in an encoded bitstream. In some instances, the variable length code may also indicate whether a prediction offset is applied when coding depth data. The variable length code may allow DMM information to be indicated in an encoded bitstream with relatively fewer bits than the fixed length code noted above.

In an example, when a PU size is larger than 4×4, DMM mode 1 may be signaled using two bits and DMM mode 3 and 4 may be signaled using 3 bits, as shown in Table 6 below.

TABLE 6
Variable Length Binarizaton of dmm_mode

| dmm_mode | DMM mode | Delta DC | Binary string |
|---|---|---|---|
| 0 | DMM mode 1 | not used | 00 |
| 1 | DMM mode 1 | used | 01 |
| 2 | DMM mode 3 | not used | 100 |
| 3 | DMM mode 3 | used | 101 |
| 4 | DMM mode 4 | not used | 110 |
| 5 | DMM mode 4 | used | 111 |

Accordingly, Table 6 illustrates one example of a variable length code for a syntax element indicating DMM information. In another example, DMM mode 3 may be signaled using two bits and DMM mode 1 and 4 may be signaled using 3 bits. In still another example, DMM mode 4 may be signaled using two bits and DMM mode 1 and 3 may be signaled using 3 bits.

The assignment of DMMs to particular variable length bin strings may depend, for example, on the usage of DMMs. For example, a video encoder (such as video encoder 20) may assign the shortest DMM information codeword to the most used DMM for a particular depth map or series of depth maps. A video decoder (such as video decoder 30) may be configured to adjust the mapping in a similar way.

An example of syntax changes (relative to the current version of 3D-HEVC) for the techniques described above are shown in the tables below, where bold and italics indicate additions to the specification, and [symbol] indicate deletions.

TABLE 7
DMM Coding Unit Syntax
G.7.4.9.1 General coding unit syntax

| coding_unit(x0, y0, log2CbSize, ctDepth) { | Descriptor |
|---|---|
| if(transquant_bypass_enable_flag ) { | |
| cu_transquant_bypass_flag | ae(v) |
| } | |
| if(slice_type != I && !MotionInhFlag[x0][y0]) | |
| skip_flag[x0][y0] | ae(v) |
| if(skip_flag[x0][y0]) | |
| prediction_unit(x0, y0, log2CbSize) | |
| else { | |
| if(!MotionInhFlag[x0][y0]) { | |
| nCbS = (1 << log2CbSize) | |
| if(slice_type != I) | |
| pred_mode_flag | ae(v) |
| if(PredMode == MODE_INTRA && DepthFlag) | |
| sdc_flag[x0][y0] | ae(v) |
| if(sdc_flag[x0][y0]) { | |
| . . . | |
| }else { | |
| if( (PredMode[x0][y0] ! = MODE_INTRA \|\| log2CbSize == | |
| Log2MinCbSize) && | |
| !predPartModeFlag) | |
| part_mode | ae(v) |
| if(PredMode[x0][y0] == MODE_INTRA) { | |
| if(PartMode == PART_2Nx2N && pcm_enabled_flag && | |
| log2CbSize >= Log2MinIPCMCUSize && | |
| log2CbSize <= Log2MaxIPCMCUSize) | |
| pcm_flag | ae(v) |
| if(pcm_flag) { | |
| num_subsequent_pcm | tu(3) |
| NumPCMBlock = num_subsequent_pcm + 1 | |
| while(!byte_aligned( )) | |
| pcm_alignment_zero_bit | f(1) |
| pcm_sample(x0, y0, log2CbSize) | |
| } else { | |
| pbOffset = (PartMode == PART_NxN) ? (nCbS/2) : 0 | |
| if (enable_DMM_flag && log2CbSize <= | |
| Log2MaxDmmCbSize) { | |
| for(j = 0; j <= pbOffset; j = j + pbOffset) | |
| for(i = 0; i <= pbOffset; i = i + pbOffset) | |
| dmm_flag[x0 + i][y0 + j] | ae(v) |
| for(j = 0; j <= pbOffset; j = j + pbOffset) | |
| for(i = 0; i <= pbOffset; i = i + pbOffset) | |
| if (dmm_flag[x0 + i][y0 + j]) | |
| dmm_mode[x0 + i][y0 + j] | ae(v) |
| for(j = 0; j <= pbOffset; j = j + pbOffset) | |
| for(i = 0; i <= pbOffset; i = i + pbOffset) | |
| if (dmm_flag[x0 + i][y0 + j] && ( | |
| dmm_mode[x0 + i][y0 + j] == | |
| MODE_DMM_WFULL \|\| | |
| dmm_mode[x0 + i][y0 + j] == | |
| MODE_DMM_WFULLDELTA)) | |
| wedge_full_tab_idx[x0 + i][y0 + i] | ae(v) |
| 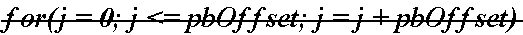 | |
| 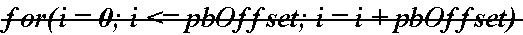 | |
| 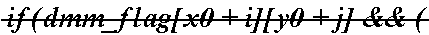 | |
| 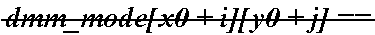 | |
| 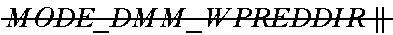 | |
| 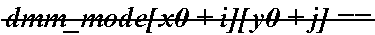 | |
| 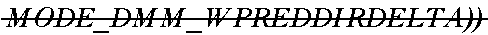 | |
| 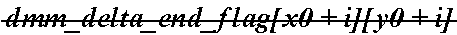 | 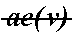 |
| 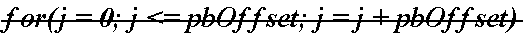 | |
| 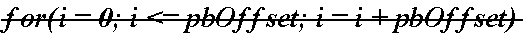 | |
| 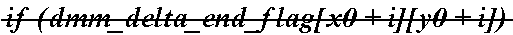 | |
| 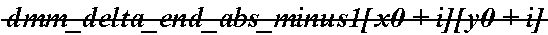 | 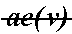 |
| 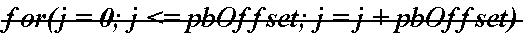 | |
| 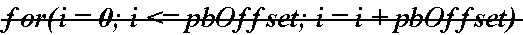 | |
| 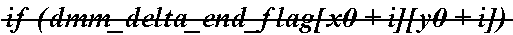 | |
| 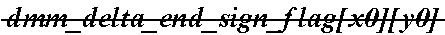 | 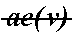 |
| 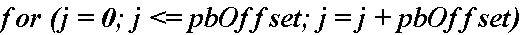 | |
| 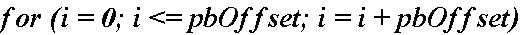 | |
| DmmDeltaFlag[x0 + i][y0 + i] = ( | |
| dmm_flag[x0 + i][y0 + j] && ( | |
| dmm_mode[x0 + i][y0 + i] == | |
| MODE_DMM_WFULLDELTA \|\| | |
| 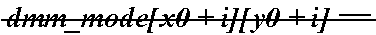 | |
| 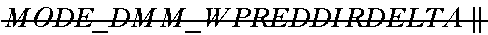 | |
| dmm_mode[x0 + i][y0 + i] == | |
| MODE_DMM_WPREDTEXDELTA \|\| | |
| dmm_mode[x0 + i][y0 + i] == | |
| MODE_DMM_CPREDTEXDELTA)) | |
| for(j = 0; j <= pbOffset; j = j + pbOffset) | |
| for(i = 0; i <= pbOffset; i = i + pbOffset) | |
| if (DmmDeltaFlag[x0 + i][y0 + i]) | |
| dmm_dc_1_abs[x0 + i][y0 + i] | ae(v) |
| for(j = 0; j <= pbOffset; j = j + pbOffset) | |
| for(i = 0; i <= pbOffset; i = i + pbOffset) | |
| if (DmmDeltaFlag[x0 + i][y0 + j] && | |
| −dmm_dc_1_abs[x0 + i][y0 + i] != 0) | |
| dmm_dc_1_sign_flag[x0 + i][y0 + i] | ae(v) |
| for(j = 0; j <= pbOffset; j = j + pbOffset) | |
| for(i = 0; i <= pbOffset; i = i + pbOffset) | |
| if (DmmDeltaFlag[x0 + i][y0 + j]) | |
| dmm_dc_2_abs[x0 + i][y0 + i] | ae(v) |
| for(j = 0; j <= pbOffset; j = j + pbOffset) | |
| for(i = 0; i <= pbOffset; i = i + pbOffset) | |
| if (DmmDeltaFlag[x0 + i][y0 + j] && | |
| dmm_dc_2_abs[x0 + i][y0 + i] != 0) | |
| dmm_dc_2_sign_flag[x0 + i][y0 + i] | ae(v) |
| intra_chroma_pred_mode[x0][y0] | ae(v) |
| . . . | |

As shown in the example of Table 7 above, DMM mode 2 is removed, thereby disabling mode 2 from being applied to code depth data. In the example table above, dmm_flag[x0][y0] equal to 0 may indicate that DMMs are not used. In addition, dmm_flag[x0][y0] equal to 1 may indicate that DMMs are used, and that the dmm_mode syntax element is also present. When the dmm_flag[x0][y0] is not present, its value may be inferred to be equal to 0.

In addition, dmm_mode[x0][y0] may be set to one of the values shown in Table 8 below.

TABLE 8
Interpretation of dmm_mode

| dmm_mode | Method identifier |
|---|---|
| 0 | MODE_DMM_WFULL |
| 1 | MODE_DMM_WFULLDELTA |
| 2 | MODE_DMM_WPREDTEX |
| 3 | MODE_DMM_WPREDTEXDELTA |
| 4 | MODE_DMM_CPREDTEX |
| 5 | MODE_DMM_CPREDTEXDELTA |
| 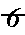 | 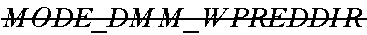 |
| 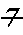 | 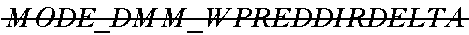 |

Additional changes to the current version of 3D-HEVC) for the techniques described above are provided below, where bold and italics indicate additions to the specification, and [symbol] indicate deletions:

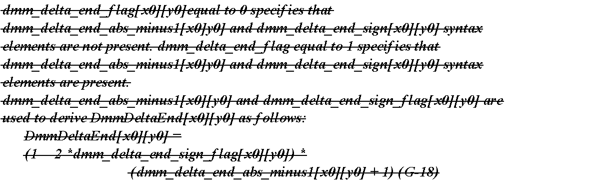

dmm_dc_{—}0_abs[x0][y0], dmm_dc_{—}0_sign_flag[x0][y0],
dmm_dc_{—}1_abs[x0][y0], dmm_dc_{—}1_sign_flag[x0][y0] are used to derive
QuantDCOffsetP0[x0][y0] and QuantDCOffsetP1[x0][y0] values as follows:
   QuantDCOffsetP0[x0][y0]=(1−2*dmm_dc_{—}0_sign_flag[x0][y0])*dmm_dc_{—}0 abs[x0][y0] (G-19)
   QuantDCOffsetP1[x0][y0]=(1−2*dmm_dc_{—}1_sign_flag[x0][y0])*dmm_dc_{—}1_abs[x0][y0] (G-20)
. . .

### G.8.4.2.2.1 General Intra Sample Prediction

The specification in subclause 8.4.4.2.1 with the following paragraphs added to the end of subclause apply:
Otherwise, if intraPredMode is equal to Intra DepthPartition(35,36), the corresponding intra prediction mode specified in subclause G.8.4.4.2.7 is invoked with the location (xB0, yB0), the intra prediction mode intraPredMode, the sample array p and the transform block size nT as the inputs and the output are the predicted sample array predSamples.
Otherwise, if intraPredMode is equal to Intra DepthPartition(37,38), the corresponding intra prediction mode specified in subclause G.8.4.4.2.8 is invoked with the location (xB0, yB0), the intra prediction mode intraPredMode, the sample array p and the transform block size nT as the inputs and the output are the predicted sample array predSamples.
Otherwise, if intraPredMode is equal to Intra DepthPartition(39,40), the corresponding intra prediction mode specified in subclause G.8.4.4.2.9 is invoked with the location (xB0, yB0), the intra prediction mode intraPredMode, with the sample array p and the transform block size nT as the inputs and the output are the predicted sample array predSamples.

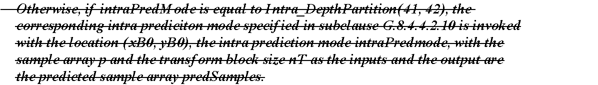

Otherwise, if intraPredMode is equal to Intra Chain(43,44), the corresponding intra prediction mode specified in subclause G.8.4.4.2.11 is invoked with the location (xB0, yB0), the intra prediction mode intraPredMode, with the sample array p and the transform block size nT as the inputs and the output are the predicted sample array predSamples.

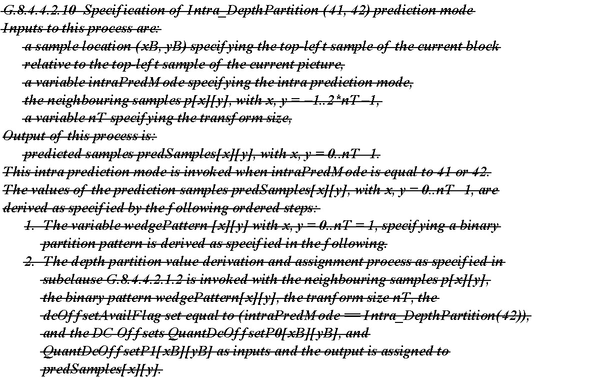

### G.9.3.1.1 Initialization Process for Context Variables

. . .

TABLE G-6
Association of ctxIdx and syntax elements for each initializationType
in the initialization process

| | | | initType | | |
|---|---|---|---|---|---|
| | Syntax element | ctxIdxTable | 0 | 1 | 2 |
| coding_unit( ) | dmm_flag | Table G-7 | 0 | 1 | 2 |
| | dmm_mode | Table G-8 | 0 | 1 | 2 |
| | wedge_full_ tab_idx | Table G-9 | 0 | 1 | 2 |
| | 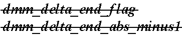 | 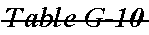 | 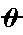 | 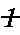 | 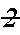 |
| | dmm_dc_1_abs | Table G-11 | 0 | 1 | 2 |
| | dmm_dc_2_abs | | | | |
| | res_pred_flag | Table G-12 | 0 | 1 | 2 |
| | ic_flag | Table G-13 | | 0 | 1 |
| | mvp_10_idx | Table G-14 | | 0..1 | 2..3 |
| | mpv_11_idx | | | | |
| | sdc_flag | Table G-15 | 0..2 | 3..5 | 6..8 |
| | sdc_residual_flag | Table G-16 | 0..1 | 2..3 | 4..5 |
| | sdc_residual_sign_flag | Table G-17 | 0 | 1 | 2 |
| | sdc_residual_abs_minus1 | Table G-18 | 0..19 | 20..39 | 40..59 |
| | sdc_pred_mode | Table G-19 | 0..2 | 3..5 | 6..8 |

### G.9.3.2 Binarization Process

The specifications in subclause 9.3.2 apply with the following modifications.
Table G-20 is appended to the end of Table 9-37.

TABLE G-20
Syntax elements and associated types of binarization, maxBinIdxCtx,
ctxIdxTable, and ctxIdxOffset

| | | | Max | | |
|---|---|---|---|---|---|
| | | | Bin | | |
| | Init | | Idx | ctxIdx | ctxIdx |
| Syntax element | Type | Type of binarization | Ctx | Table | Offset |
| . . . | . . . | . . . | . . . | . . . | . . . |
| dmm_mode | 0 1 2 | 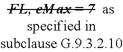 | 0 0 0 | Table G-8 Table G-8 Table G-8 | 0 1 2 |
| wedge_full_tab_idx | 0 | FL, cMax = | 0 | Table G-9 | 0 |
| | | dmmWedgeletPattern | | | |
| | | ListSize | | | |
| | 1 | . . . | 0 | Table G-9 | 1 |
| | 2 | | 0 | Table G-9 | 2 |
| 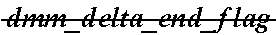 | 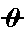 | 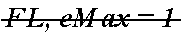 | 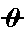 | 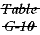 | 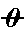 |
| | 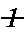 | | 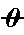 | 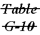 | 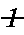 |
| | 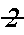 | | 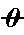 | 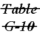 | 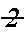 |
| 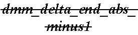 | 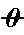 | 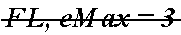 | 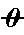 | 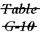 | 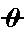 |
| | 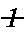 | | 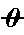 | 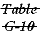 | 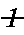 |
| | 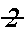 | | 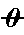 | 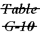 | 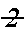 |
| 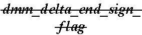 | 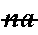 | 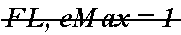 | 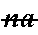 | 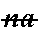 | 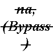 |
| dmm_dc_1_abs | 0 | UEG0 | 0 | Table G-11 | 0 |
| dmm_dc_2_abs | 1 | | 0 | Table G-11 | 1 |
| | 2 | | 0 | Table G-11 | 2 |
| . . . | . . . | . . . | . . . | . . . | . . . |
| . . . | . . . | . . . | . . . | . . . | . . . |

G.9.3.2.10 Binarization Process for dmm_mode

Input to this process is a request for a binarization for the syntax element dmm_mode.

Output of this process is the binarization of the syntax element.

The binarization of the syntax element dmm_mode depends whether log2CbSize is larger than 4. Table G-35 specifies the binarization of dmm_mode.

TABLE G-21
Binarization for dmm_mode

| | |
|---|---|
| Value of | Bin string |

| dmm_mode | log2CbSize == 4 | log2CbSize > 4 |
|---|---|---|
| 0 | 00 | 00 |
| 1 | 01 | 01 |
| 2 | 10 | 100 |
| 3 | 11 | 101 |
| 4 | n/a | 110 |
| 5 | n/a | 111 |

G.9.3.3.1 Derivation Process for ctxIdx

The specifications in subclause 9.3.3.1 apply with the following modifications.
Table G-21 is appended to the end of Table 9-37.

TABLE G-21
Assignment of ctxIdxInc to syntax elements with context coded bins

| | binIdx | | | | | |
|---|---|---|---|---|---|---|
| Syntax element | 0 | 1 | 2 | 3 | 4 | >=5 |
| dmm_flag | 0 | na | na | na | na | na |
| dmm_mode | 0 | 0 | 0 | 0 | 0 | 0 |
| wedge_full_tab_idx | 0 | 0 | 0 | 0 | 0 | 0 |
| [symbol] | [symbol] | [symbol] | [symbol] | [symbol] | [symbol] | [symbol] |
| [symbol] | [symbol] | [symbol] | [symbol] | [symbol] | [symbol] | [symbol] |
| [symbol] | 0 | 0 | 0 | 0 | 0 | 0 |
| dmm_dc_2_abs | | | | | | |
| res_pred_flag | 0 | na | na | na | na | na |
| ic_flag | 0 | na | na | na | na | na |
| mvp_l0_idx, | 0 | 1 | na | na | na | na |
| mvp_l1_idx | | | | | | |
| sdc_flag | 0, 1, 2 | na | na | na | na | na |
| | (subclause | | | | | |
| | G.9.3.3.1.1) | | | | | |
| sdc_residual_flag | 0, 1 | na | na | na | na | na |
| | (subclause | | | | | |
| | G.9.3.3.1.7) | | | | | |
| sdc_residual_sign_flag | 0, 1 | na | na | na | na | na |
| | (subclause | | | | | |
| | G.9.3.3.1.7) | | | | | |
| sdc_residual_abs_minus1 | 0, 10 | | | | | |
| | (subclause G.9.3.3.1.7) | | | | | |
| sdc_pred_mode | 0 | 1 | 2 | na | na | na |

In another example, the same syntax, semantics and decoding process described above may be applied, however, the binarization process for dmm_mode may be modified as shown below:

G.9.3.2.10 Binarization Process for dmm_mode

Input to this process is a request for a binarization for the syntax element dmm_mode.

Output of this process is the binarization of the syntax element.

The binarization of the syntax element dmm_mode depends whether log2CbSize is larger than 4. Table G-35 specifies the binarization of dmm_mode.

TABLE G-21
Binarization for dmm_mode

| | |
|---|---|
| Value of | Bin string |

| dmm_mode | log2CbSize == 4 | log2CbSize > 4 |
|---|---|---|
| 0 | 00 | 00 |
| 1 | 10 | 10 |
| 2 | 01 | 010 |
| 3 | 11 | 110 |
| 4 | n/a | 011 |
| 5 | n/a | 111 |

In general, the examples described above remove DMM mode 2 from the specification and allow the remaining DMMs to be signaled using a variable length code. As noted above, such techniques may reduce the complexity associated with DMM coding and increase the efficiency with which DMMs may be indicated in an encoded bitstream.

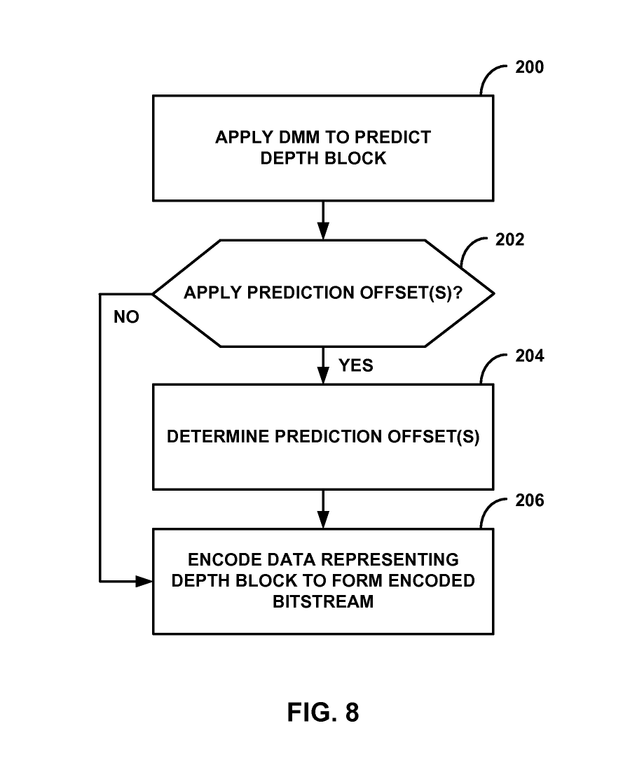

FIG. 8 is a flow diagram illustrating an example process for encoding depth data based on a DMM, according to aspects of this disclosure. While the process shown in FIG. 8 is generally described as being carried out by video encoder 20 (FIGS. 1 and 2), it should be understood that the techniques may be performed by a variety of other codecs and/or processors.

In the example of FIG. 8, video encoder 20 applies a DMM to predict a depth block (200). For example, as noted above, video encoder 20 may select the DMM to apply based on a rate-distortion analysis for available DMMs. According to aspects of this disclosure, as noted above, the available DMMs may not include a DMM that predicts partition boundaries based on neighboring depth blocks, such as DMM mode 2 of 3D-HEVC. In any case, video encoder 20 may split depth block into two partitions and generate a predicted value for each partition.

After predicting the depth block with the selected DMM, video encoder 20 may determine whether to apply one or more prediction offsets to the predicted value for each partition (202). For example, as noted above, the prediction offsets may be referred to as delta DCs, and may be used in instances in which the predicted value does not match the actual depth values of the depth block being encoded. If one or more prediction offsets are used, video encoder 20 may determine the appropriate prediction offsets (204).

Video encoder 20 then encodes data representing the depth block to form an encoded bitstream (206). For example, video encoder 20 may encode data representing one or more DMM syntax elements, which indicate which DMM was used to predict the depth block, as well as, in some examples, whether a prediction offset was applied. According to aspects of this disclosure, video encoder 20 may use a variable length code to signal a DMM syntax element (as described, for example, with respect to FIGS. 7A and 7B above) that indicates the DMM information. In some instances, video encoder 20 may also encode data representing residual depth values, when there is a difference between the predicted depth values and the actual depth values of the depth block.

It should be understood that the steps shown in FIG. 8 are provided as merely one example. That is, the steps shown in FIG. 8 need not necessarily be performed in the order shown, and fewer, additional, or alternative steps may be performed.

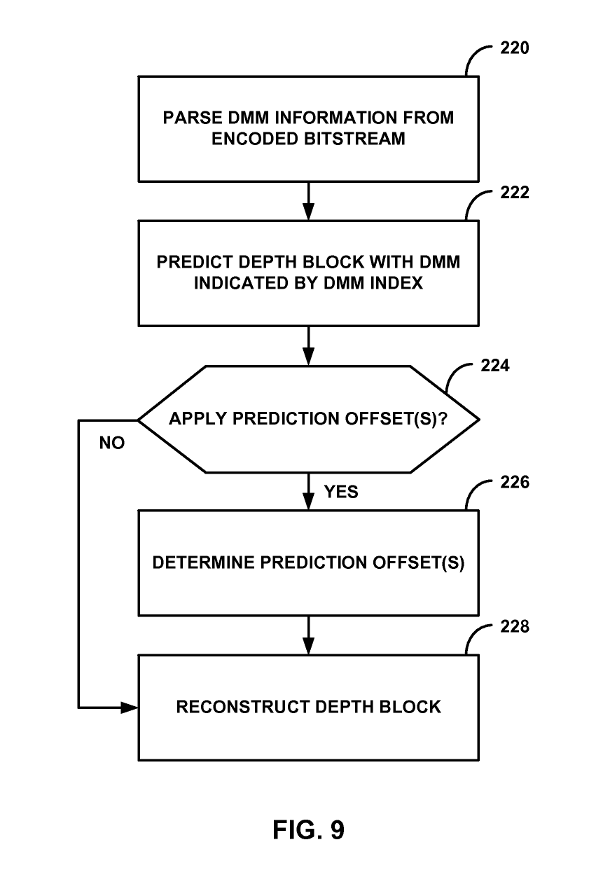

FIG. 9 is a flow diagram illustrating an example process for decoding depth data based on a DMM, according to aspects of this disclosure. While the process shown in FIG. 9 is generally described as being carried out by video decoder 30 (FIGS. 1 and 3), it should be understood that the techniques may be performed by a variety of other codecs and/or processors.

In the example of FIG. 9, video decoder 30 may parse DMM information from an encoded bitstream containing data representing a depth block (220). For example, according to aspects of this disclosure, video decoder 30 may parse bins of a variable length code associated with a DMM syntax element from the bitstream (as described, for example, with respect to FIGS. 7A and 7B above). Video decoder 30 may determine, based on the variable length code, a DMM index that identifies a DMM in a table of DMMs, as well as whether to decode and apply a prediction offset to the result of the DMM.

Video decoder 30 may then predict the depth block being decoded based on the DMM indicated by the DMM index (222). As noted above, video decoder 30 may predict the depth block by determining partition boundaries for the depth block and generating a predicted depth value for each partition of the depth block. Video decoder 30 also determines whether to apply a prediction offset to the predicted values (224). Video decoder 30 may determine whether to apply a prediction offset based on the decoded DMM syntax element described above.

If a prediction offset is applied, video decoder 30 may determine the prediction offset based on data representing the prediction offset from the encoded bitstream (226). Video decoder 30 may then reconstruct the depth block based on the predicted depth values (228). For example, in instances in which there are prediction offsets, video decoder 30 may set the depth values for each partition of the block to the predicted depth values. In instances in which there are on or more prediction offsets, video decoder 30 may combine the prediction offsets with the predicted values for each partition to generate the actual depth values for the block.

It should be understood that the steps shown in FIG. 9 are provided as merely one example. That is, the steps shown in FIG. 9 need not necessarily be performed in the order shown, and fewer, additional, or alternative steps may be performed.

The techniques described above may be performed by video encoder 20 (FIGS. 1 and 2) and/or video decoder 30 (FIGS. 1 and 3), both of which may be generally referred to as a video coder. In addition, video coding may generally refer to video encoding and/or video decoding, as applicable.

While the techniques of this disclosure are generally described with respect to 3D-HEVC, the techniques are not limited in this way. The techniques described above may also be applicable to other current standards or future standards not yet developed. For example, the techniques for depth coding may also be applicable to a multi-view extension of HEVC (e.g., so called MV-HEVC), a scalable extension to HEVC, or other current or future standards having a depth component.

It should be understood that, depending on the example, certain acts or events of any of the methods described herein can be performed in a different sequence, may be added, merged, or left out all together (e.g., not all described acts or events are necessary for the practice of the method). Moreover, in certain examples, acts or events may be performed concurrently, e.g., through multi-threaded processing, interrupt processing, or multiple processors, rather than sequentially. In addition, while certain aspects of this disclosure are described as being performed by a single module or unit for purposes of clarity, it should be understood that the techniques of this disclosure may be performed by a combination of units or modules associated with a video coder.

While particular combinations of various aspects of the techniques are described above, these combinations are provided merely to illustrate examples of the techniques described in this disclosure. Accordingly, the techniques of this disclosure should not be limited to these example combinations and may encompass any conceivable combination of the various aspects of the techniques described in this disclosure.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium and packaging materials.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other aspects are within the scope of the following claims.

What is claimed is:

1. A method of coding video data, the method comprising:
coding, with a variable length code, a syntax element indicating depth modeling mode (DMM) information for coding a depth block of video data; and
coding the depth block based on the DMM information.

2. The method of claim 1, wherein the DMM information comprises a DMM index and an indication of whether to apply a prediction offset when coding the depth block.

3. The method of claim 2, wherein the DMM index comprises one of exactly three DMM indices corresponding to exactly three DMMs.

4. The method of claim 3, wherein the exactly three DMMs comprise a first DMM associated with one or more explicitly signaled partition boundaries, a second DMM associated with one or more boundaries determined based on a co-located texture block of the depth block, and a third DMM associated with one or more partition boundaries determined based on a co-located texture block of the depth block.

5. The method of claim 2, wherein the syntax element has six associated syntax element values, each syntax element value representing a combination of one of the DMM indices and whether to apply the prediction offset.

6. The method of claim 1, further comprising assigning a shortest codeword of the variable length code to a DMM that is most frequently applied to a depth map that includes the depth block.

7. The method of claim 1, wherein the variable length code is based on a size of the depth block being coded.

8. The method of claim 1, wherein coding the syntax element and coding the depth block comprises decoding the syntax element and decoding the depth block, and wherein decoding the syntax element and decoding the depth block comprises:
parsing the syntax element from an encoded bitstream;
predicting the depth block based on a DMM indicated by the parsed syntax element; and
reconstructing the depth block based on the predicted depth block.

9. The method of claim 1, wherein coding the syntax element and coding the depth block comprises encoding the syntax element and encoding the depth block, and wherein encoding the syntax element and encoding the depth block comprises:
predicting the depth block based on a DMM associated with the syntax element;
encoding data representing the syntax element;
forming an encoded bitstream that includes the encoded data representing the syntax element.

10. An apparatus for coding video data, the apparatus comprising one or more processors configured to:
code, with a variable length code, a syntax element indicating depth modeling mode (DMM) information for coding a depth block of video data; and
code the depth block based on the DMM information.

11. The apparatus of claim 10, wherein the DMM information comprises a DMM index and an indication of whether to apply a prediction offset when coding the depth block.

12. The apparatus of claim 11, wherein the DMM index comprises one of exactly three DMM indices corresponding to exactly three DMMs.

13. The apparatus of claim 12, wherein the exactly three DMMs comprise a first DMM associated with one or more explicitly signaled partition boundaries, a second DMM associated with one or more boundaries determined based on a co-located texture block of the depth block, and a third DMM associated with one or more partition boundaries determined based on a co-located texture block of the depth block.

14. The apparatus of claim 11, wherein the syntax element has six associated syntax element values, each syntax element value representing a combination of one of the DMM indices and whether to apply the prediction offset.

15. The apparatus of claim 10, wherein the one or more processors are further configured to assign a shortest codeword of the variable length code to a DMM that is most frequently applied to a depth map that includes the depth block.

16. The apparatus of claim 10, wherein the variable length code is based on a size of the depth block being coded.

17. The apparatus of claim 10, wherein to code the syntax element and to code the depth block the one or more processors are configured to decode the syntax element and to decode the depth block, and wherein to decode, the one or more processors are configured to:
parse the syntax element from an encoded bitstream;
predict the depth block based on a DMM indicated by the parsed syntax element; and
reconstruct the depth block based on the predicted depth block.

18. The apparatus of claim 10, wherein to code the syntax element and to code the depth block, the one or more processors are configured to encode the syntax element and to encode the depth block, and wherein to encode, the one or more processors are configured to:
predict the depth block based on a DMM associated with the syntax element;
encode data representing the syntax element;
form an encoded bitstream that includes the encoded data representing the syntax element.

19. An apparatus for coding video data, the apparatus comprising:
means for coding, with a variable length code, a syntax element indicating depth modeling mode (DMM) information for coding a depth block of video data; and
means for coding the depth block based on the DMM information.

20. The apparatus of claim 19, wherein the DMM information comprises a DMM index and an indication of whether to apply a prediction offset when coding the depth block.

21. The apparatus of claim 20, wherein the DMM index comprises one of exactly three DMM indices corresponding to exactly three DMMs.

22. The apparatus of claim 21, wherein the exactly three DMMs comprise a first DMM associated with one or more explicitly signaled partition boundaries, a second DMM associated with one or more boundaries determined based on a co-located texture block of the depth block, and a third DMM associated with one or more partition boundaries determined based on a co-located texture block of the depth block.

23. The apparatus of claim 20, wherein the syntax element has six associated syntax element values, each syntax element value representing a combination of one of the DMM indices and whether to apply the prediction offset.

24. The apparatus of claim 19, further comprising means for assigning a shortest codeword of the variable length code to a DMM that is most frequently applied to a depth map that includes the depth block.

25. The apparatus of claim 19, wherein the variable length code is based on a size of the depth block being coded.

26. The apparatus of claim 19, wherein the means for coding the syntax element and the means for coding the depth block comprises means for decoding the syntax element and means for decoding the depth block, and wherein the means for decoding the syntax element and the means for decoding the depth block comprises:
means for parsing the syntax element from an encoded bitstream;
means for predicting the depth block based on a DMM indicated by the parsed syntax element; and
means for reconstructing the depth block based on the predicted depth block.

27. The apparatus of claim 19, wherein the means for coding the syntax element and the means for coding the depth block comprises means for encoding the syntax element and means for encoding the depth block, and wherein the means for encoding the syntax element and the means for encoding the depth block comprises:
means for predicting the depth block based on a DMM associated with the syntax element;
means for encoding data representing the syntax element;
means for forming an encoded bitstream that includes the encoded data representing the syntax element.

28. A non-transitory computer-readable medium storing instructions thereon that, when executed, cause one or more processors to:
code, with a variable length code, a syntax element indicating depth modeling mode (DMM) information for coding a depth block of video data; and
code the depth block based on the DMM information.

29. The non-transitory computer-readable medium of claim 28, wherein the DMM information comprises a DMM index and an indication of whether to apply a prediction offset when coding the depth block.

30. The non-transitory computer-readable medium of claim 29, wherein the DMM index comprises one of exactly three DMM indices corresponding to exactly three DMMs.

31. The non-transitory computer-readable medium of claim 30, wherein the exactly three DMMs comprise a first DMM associated with one or more explicitly signaled partition boundaries, a second DMM associated with one or more boundaries determined based on a co-located texture block of the depth block, and a third DMM associated with one or more partition boundaries determined based on a co-located texture block of the depth block.

32. The non-transitory computer-readable medium of claim 29, wherein the syntax element has six associated syntax element values, each syntax element value representing a combination of one of the DMM indices and whether to apply the prediction offset.

33. The non-transitory computer-readable medium of claim 28, further comprising instructions that cause the one or more processors to assign a shortest codeword of the variable length code to a DMM that is most frequently applied to a depth map that includes the depth block.

34. The non-transitory computer-readable medium of claim 28, wherein the variable length code is based on a size of the depth block being coded.

35. The non-transitory computer-readable medium of claim 28, wherein to code the syntax element and to code the depth block the instructions cause the one or more processors to decode the syntax element and to decode the depth block, and wherein to decode, the instructions cause the one or more processors to:
parse the syntax element from an encoded bitstream;
predict the depth block based on a DMM indicated by the parsed syntax element; and
reconstruct the depth block based on the predicted depth block.

36. The non-transitory computer-readable medium of claim 28, wherein to code the syntax element and to code the depth block, the instructions cause the one or more processors to encode the syntax element and to encode the depth block, and wherein to encode, the instructions cause the one or more processors to:
predict the depth block based on a DMM associated with the syntax element;
encode data representing the syntax element;
form an encoded bitstream that includes the encoded data representing the syntax element.
